(19) United States
(12) Patent Application Publication
(10) Pub. No.: US 2009/0108999 A1
(43) Pub. Date: Apr. 30, 2009

(54) Transponder-based appratus for space-time identification and location

(76) Inventors: Claudio Salvador, Firenze (IT); Filippo Bonifacio, Firenze (IT)

Correspondence Address: ABELMAN, FRAYNE & SCHWAB, 666 THIRD AVENUE, 10TH FLOOR, NEW YORK, NY, 10017, US

(21) Appl. No.: 11/988,201

(22) PCT Filed: Jun. 29, 2006
(86) PCT No.: PCT/IB2006/001810

§ 371 Date: Dec. 31, 2007

(30) Foreign Application Priority Data
Jul. 1, 2005 (IT) FI2005A000146

(51) Int. Cl. H04Q 5/22

(52) U.S. Cl. 340/10.1

(57) ABSTRACT

The object of the present invention relates to a dual-band transponder-based apparatus for space-time identification and location that carries out the data exchange between a query device and one or more responders, being located within an appropriate distance range from said query device.

### FIELD OF THE INVENTION

The present invention relates to the field of dual-band responder systems, named “transponders”.

More specifically, the invention relates to a dual-band transponder-based apparatus for space-time identification and location that carries out the data exchange between a query device and one or more responders, being located within an appropriate distance range from said query device.

### STATE OF THE ART

There are currently available transponder apparatuses formed by a query device (BOA) and at least one responder device (TAG) in a wireless two-way communication, wherein said (BOA) and said (TAG) are provided with means for communicating through two separate channels, one of which is for the (BOA) to activate the (TAG) being located in a predetermined activation area (MFP) and the other two-way one is to exchange data between (BOA) and said (TAG) within a second data exchange area (RFP).

Such an apparatus is described in European Patent Application n. EP1209615 submitted by the same applicant of the present application.

Typical applications of apparatuses as the previously described one are all those in which a data exchange between a query device and a responder is required, after such a request is transmitted by either of the two.

Examples of use may be access-check and existence-check computer gates and the data exchange within a given region between a user and a determined device such as a personal computer, a peripheral device, a storage unit etc.

There are not included in the scopes related to the state of the art devices, all the applications in which it is required to correlate a space identification, already carried out by these devices, to a time identification, by the transponder or responder, so as to render its location single, both in terms of space and in terms of time.

Examples of state of the art devices adapted to perform said time identification are disclosed in the following documents: EP542509 (BIANCO JAMES ET AL) discloses a similar system in which a plurality of transmitter located throughout a travel route broadcast a location number uniquely identifying that transmitter and its location. When a receiver, located on an object or on a user being monitored, detects the carrier frequency of a transmitter, activates a microprocessor which stores into a memory the ID number of that transmitter and date and time of the transmission. When the receiver is taken to a home base said memory can be unloaded and the travel route determined and analyzed. The system is single frequency and no further data, beside a trivial battery status of the transmitter, is broadcasted with obvious limitations. EP1376272 (ASTRA GES FUER ASSET MAN MBH) discloses a method and a device for automatic timing in sport events based on the use of transponders—provided to each participant to the sport event—carrying an ID which is transmitted to a receiver upon finishing of the sport event and associated with a recorded time. The data transmitted and received relates only to ID and time, they are stored in a memory located on the receiver device and later evaluated and verified as error-free. Again the system is working with a single frequency channel. U.S. Pat. No. 4,658,357 (CARROLL GARY ET AL) discloses a portable device that is capable of storing a time log related to the places where the person wearing said device has been. The architecture of the device according to U.S. Pat. No. 4,658,357 is single frequency and the signals transmitted and received have a limited range and they only concern an unique code which is time-logged into a memory element contained within the portable receiving unit of the device. A computer is needed to analyze data logqed within the units of the device according to U.S. Pat. No. 4,658,357 and the characterizing part of claim one concerns a particular way of processing the above data. None of the above documents discloses a device which is adapted to perform communication on a multi frequency double link and is provided with means to temporally mark every data exchanged and to further manage external memory devices and external parametric sensors in a compact and portable fashion without requiring external post-processing devices.

Many could be the potential uses of such an apparatus, ranging from the timing determinations in sport competitions to the management of stocks, to the real-time control and management of commercial yielders, to the management and control

### FIELD OF THE INVENTION

The present invention relates to the field of dual-band responder systems, named “transponders”.

More specifically, the invention relates to a dual-band transponder-based apparatus for space-time identification and location that carries out the data exchange between a query device and one or more responders, being located within an appropriate distance range from said query device.

### STATE OF THE ART

There are currently available transponder apparatuses formed by a query device (BOA) and at least one responder device (TAG) in a wireless two-way communication, wherein said (BOA) and said (TAG) are provided with means for communicating through two separate channels, one of which is for the (BOA) to activate the (TAG) being located in a predetermined activation area (MFP) and the other two-way one is to exchange data between (BOA) and said (TAG) within a second data exchange area (RFP).

Such an apparatus is described in European Patent Application n. EP1209615 submitted by the same applicant of the present application.

Typical applications of apparatuses as the previously described one are all those in which a data exchange between a query device and a responder is required, after such a request is transmitted by either of the two.

Examples of use may be access-check and existence-check computer gates and the data exchange within a given region between a user and a determined device such as a personal computer, a peripheral device, a storage unit etc.

There are not included in the scopes related to the state of the art devices, all the applications in which it is required to correlate a space identification, already carried out by these devices, to a time identification, by the transponder or responder, so as to render its location single, both in terms of space and in terms of time.

Many could be the potential uses of such an apparatus, ranging from the timing determinations in sport competitions to the management of stocks, to the real-time control and management of commercial yielders, to the management and control of resources, materials, and people in both civil and military logistics, from the control of the movements of instrumentation and apparatuses supplied to laboratories and offices to the control for statistic purposes of the circulation of a given group of people within a determined working area.

Therefore, it is the object of the present invention to introduce a transponder apparatus comprised of a query device and at least a responder device in a wireless two-way communication characterised in that the responder device includes means to temporally mark every data exchange carried out by means of said query device.

### SUMMARY OF THE INVENTION

The present invention relates to an apparatus for space-time identification and location comprising a dual-band transponder capable of carrying out the data exchange between a query device and one or more responders, in a wireless two-way communication between two separate channels, named up-link and down-link channels, said responders being located within an appropriate distance range from said query device, characterised in that said responder devices include means to temporally mark every data exchange carried out by means of said query device.

### BRIEF DESCRIPTION OF THE DRAWINGS

FIG. 1 is a block diagram of the structure of the apparatus according to the present invention.

FIG. 2 is a block diagram of the integrated version of the apparatus according to the present invention.

FIG. 3 is a block diagram of the timing-transponder device according to the present invention.

### DETAILED DESCRIPTION OF THE INVENTION

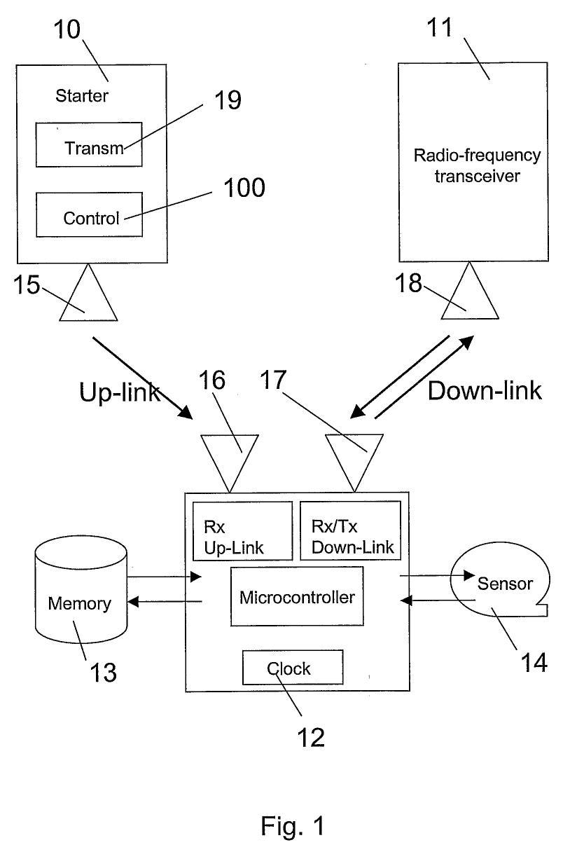

Referring to FIG. 1, the subject apparatus of the present invention includes a micro-wave, millimetre or optical waveband illuminator/programmer 10—hereinafter defined as starter—a radio-frequency transceiver 11 and a device, hereinafter defined as timing-transponder, comprising a time-measuring device 12.

Said timing-transponder is capable of carrying out time-measurements, receiving information on the micro-wave, millimetre or optical waveband channel, named up-link channel, and exchanging information and data on a radio-frequency two-way channel, named down-link channel.

In a preferred embodiment of the subject apparatus of the present invention, said timing-transponder is such that it manages external memory devices 13 and external parametric sensors 14.

In a further preferred embodiment of the apparatus according to the present invention said starter includes a micro-wave, millimetre or optical waveband transmitter and a control device, based on a stand-alone microprocessor or connected to a remote host or to any remote computer network.

The operation of the apparatus according to the present invention is carried out in accordance with the usual modes for transponder devices.

Referring to FIG. 1, starter 10 and timing-trasponder 12 communicate through a microwave millimetre or optical waveband channel, or “layer”, performing the activation/programming function of the timing-transponders themselves.

The timing-transponder 12 and the radio-frequency transceiver 11 reciprocally communicate through a two-way radio-frequency channel or “layer” which is separate and does not interfere with the microwave, millimetre or optical waveband channel for the two-way data exchange between starter 10 and timing-transponder 12.

Said two communication channels correspond to the microwave or millimetre waveband antenna 15 or the optical transmitter associated to starter 10 and antenna 18 associated to transceiver 11 and two antennas 16, 17 associated to said timing-transponder 12.

Antenna 16 may be a microwave or millimetre waveband antenna or it may be an optical receiver; antenna 17 is connected to the radio-frequency transceiver on said timing-transponder 12.

The antennas associated to said microwave communication channel may be characterised by high directivity so as to achieve the desired space discrimination in the activation step of the timing-transponder 12.

The antenna corresponding to said radio-frequency layer channel is preferably an omnidirectional antenna, in order to allow a communication having a wide range and no reciprocal orientation limits between said starter 10 and said timing-transponder 12.

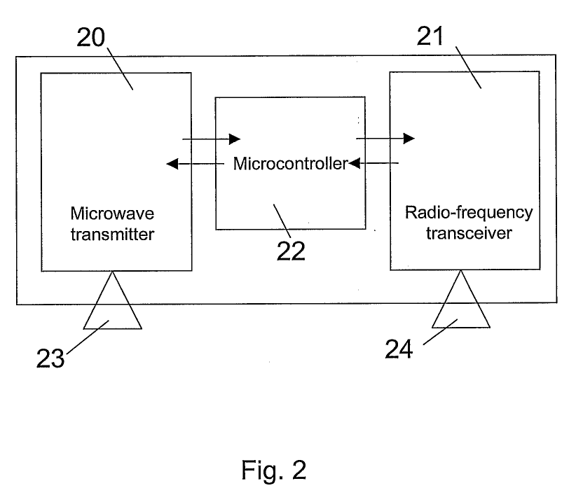

Referring to FIG. 2, representing a preferred embodiment of the apparatus according to the present invention, said starter and said radio-frequency transceiver may be integrated in a single device including a microwave transmitter 20, a radio-frequency transceiver 21, one or more microprocessor units 22, and a software, on said microprocessor 22, which drives the output of the microwave signal of the microwave communication layer, manages transceiver 21 and may perform a series of accessory control and management functions, as e.g.:

Starting, resetting, setting out again, synchronising the chronometer of the timing-transponder.

Requesting the storage of the instant time data measured by the chronometer on the memory of the timing-transponder.

Requesting the receiving, the storage and, if necessary, the retransmission of data existing on the radio-frequency down-link channel.

Allowing the synchronization of the chronometer on the timing-transponder with a reference chronometer, the time data of which are transmitted by the starter itself on the microwave, millimetre or optical waveband up-link channel during activation step or on the down-link channel by the radio-frequency transceiver.

Requesting the acquisition and storage of parameters measured by integrated sensors on the timing-transponder.

Parameterising the following transmissions of the timing-transponder indicating the periodicity and the type of data thereof to be transmitted on the down-load channel (periodic beeper).

Parameterising the following acquisitions and storages of parameters measured by sensors indicating the periodicity and the storage modes and the time mark thereof.

Defining the protocol or communication standard and the data format to be used for communications on the down-load channel.

The microwave transmitter 20 is associated to a directional antenna 23 and the radio-frequency transceiver is associated to an omnidirectional antenna 24.

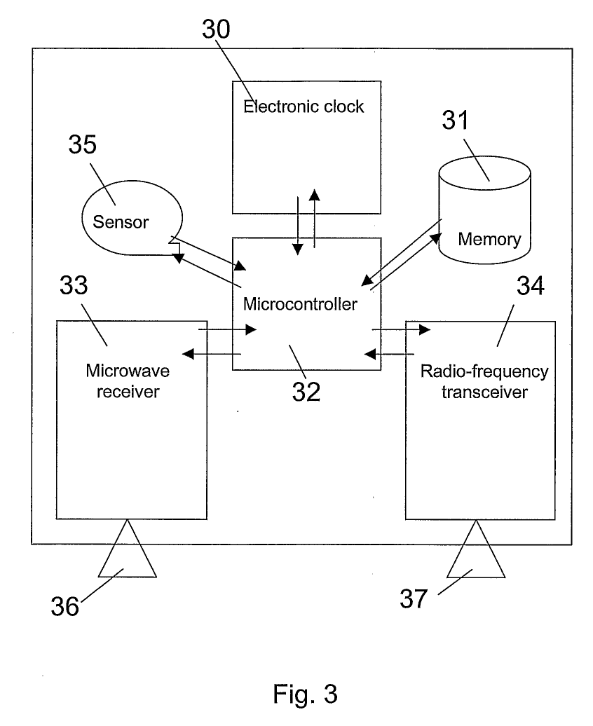

On the other hand, said timing-transponder 12 includes in turn, as shown in FIG. 3, an electronic clock 30, at least one volatile or non-volatile memory 31, at least one microprocessor 32, a microwave receiver 33, a transmitter or a radio-frequency transceiver 34 and may be connected to at least one parametric sensor 35 as, for example, a temperature, pressure, humidity, opening or anti-tampering sensor etc.

The microwave receiver is connected to a microwave antenna 36 and the radio-frequency transceiver is connected to an omnidirectional antenna 37.

Said electronic clock 30 of the timing-transponder 12 may be programmed by means of coded digital information received through the microwave or millimetre or optical waveband receiver 33 from the starter on the up-link channel or also through the radio-frequency transceiver 34 on the down-link channel, but only after being activated by the starter.

Preferred embodiments of the apparatus according to the present invention may be used according to the hardware architecture and the dedicated software executed by said microprocessors 22, 23, for the following activities:

automatic real time and non-real time control and surveillance of yielders;

real time and non-real time automated inventory;

high precision timing for sport competitions;

monitoring and automatic tracking of mobile means, people and objects usable for security systems, automatic toll or parking pay systems, building automation and industrial automation in general;

research, monitoring and automatic tracking of mobile means, people and objects usable for integrated logistics systems, in the civil, industrial and military fields, both in standard conditions and operative sceneries;

automatic acquisition of systematic data from environmental sensors or measuring means.

More in detail, a tracking system for objects, people or resources (often defined as an asset management system), may be implemented as follows: one or more starters are positioned at the accesses to a determined region of space that is required to be monitored. Every object, person or resource to be monitored within the defined region is associated to a timing-transponder instead.

Upon access in the region to monitor, the starter activates the timing-transponder and programmes it so that it periodically transmits, with a period defined by the internal clock of the timing-transponder, a predefined code, which may be incremental, until an opposite command is received. Among the information transmitted by the starter to the timing-transponder, there may also be, for instance, the code of the zone, in which the timing-transponder, and thus the object connected thereto, is positioned.

The above opposite command is ordered by a further starter positioned at the exit from the controlled zone operating so as to reprogram the timing-transponder, for instance in order not to periodically transmit the code any longer or to provide the new code to be transmitted relative to the zone in which it is shifted.

The timing-transponder uses its clock to synchronise periodic transmissions of its identification code or the acquisition, storage, and/or re-transmission of possible other information deriving from sensors positioned on the mobile device, positioned on the object to monitor.

The architecture of a possible control system employing the apparatus for space-time identification and location according to the present invention will be equipped with stand-alone or network connected transceivers in order to allow the system to detect the state and space-time position of the mobile device itself and of whatever is integrally connected and associated thereto.

Said control system may for instance comprise a network of receivers and starters connected to a server or control unit, which will function to allow the location of the various timing-transponders.

The spatial location may take place both on the basis of the code of the starter and by association to the receiver receiving the data, because radio coverage of the receiver defines a determined intervention zone. The data received from the receiver network will then, for example, be transferred to the control server, which on the basis of appropriate management software processes and updates the database. All of the asset management functions required are then implemented on the basis of the information that resides in the database which is virtually updated in real time.

All of the synchronised information, obtained from the timing-transponders, is used by the control system to update in real time the presence, position, operation and administrative state etc. of the objects, people or resources connected to the timing-transponders.

A further preferred use of the apparatus according to the present invention relates to an automatic timing system with microwave trigger.

In detail, the mobile device, formed by the timing-transponder provided with connection interfaces to external parametric memories and sensors, is integral with the resource, person or object, the movements of which are to be timed.

The timing-transponder is linked to the absolute time, receiving the appropriate trigger signal on the up-link distance (microwave, millimetre or optical waveband) from a starter. The absolute time data may be transferred on the transponder both using the communication with the starter, connected to an “absolute” clock, on the up-link distance in the activation step, or receiving such time data on the down-link radio-frequency distance, continuously transmitted by the radio-frequency transmitter connected in turn to the absolute clock.

The starter, provided with a directional microwave or millimetre waveband antenna, continuously transmits the coded trigger signal (up-link distance), which may be a simple reset code or it may in turn contain the reference time data.

As soon as the mobile device receives the microwave trigger, it stores the reference time data transmitted either on the up-link distance or on the down-link distance.

On such signal, the integrated chronometer is synchronised and autonomously starts measuring the deviations (relative and partial times) or the absolute time, and may store the time slots separating several events associated to several starters or to consecutive transmissions of the same starter.

After an appropriate command ordered by a starter, the timing-transponder may transmit on the down-link channel the complete or partial contents of its memory associated to its identification code.

A further preferred use of the apparatus according to the present invention relates to a break-in proof or anti-tampering system.

This time the timing-transponders, appropriately associated to break-in proof or anti-tampering sensors, are positioned at the access gates of containers intended for the transport of goods or objects so that said timing-transponder may temporally mark every opening and closing of said accesses.

Consider, for instance, that said containers are stowed on a cargo ship, the timing-transponder associated to each of them are linked to the absolute time, receiving the appropriate trigger signal on the up-link distance (microwave, millimetre or optical waveband) from a fixed-type starter located in position or a portable-type starter manoeuvred by an operator. The absolute time data may be transferred on the transponder both using the communication with the starter, connected to an “absolute” clock, on the up-link distance in the activation step, or receiving such time data on the down-link radio-frequency distance, continuously transmitted by the radio-frequency transmitter connected in turn to the absolute clock. The same containers will then be stowed in the ship and carried to destination and the timing-transponders integral therewith will register and temporally mark all of the openings of the access gates detected by the break-in proof sensors interfaced with them.

Upon return to the departure harbour it will be possible to verify that the unloading of said containers has taken place according to the modes and times destined, by reading the contents of the timing-transponders associated thereto which will be able to transfer, upon an appropriate command ordered by a starter, the complete or partial contents of its memory associated to its identification code on the down-link channel.

1. An apparatus for space-time identification and location comprising a dual-band transponder capable of carrying out the data exchange between a query device and one or more responders, in a wireless two-way communication through two separate channels, named up-link and down-link channels, said responders being located in an appropriate distance range from said interrogator, comprising a starter device, a radio-frequency transceiver device and a timing-transponder device.

2. An apparatus according to claim 1, comprising a starter device, a radio-frequency transceiver device and a timing-transponder device.

3. An apparatus according to claim 2, wherein said starter comprises an antenna through which it may communicate with said timing-transponder through said up-link channel.

4. An apparatus according to claim 2, wherein said radio-frequency transceiver includes an antenna through which it may communicate with said timing-transponder through said down-link channel.

5. An apparatus according to claim 1, wherein the operating frequency of said up-link channel is chosen in the group comprising microwaves, millimetre wavelength frequencies and optical frequencies.

6. An apparatus according to claim 1, wherein said down-link channel is a two-way communication radio-frequency channel.

7. An apparatus according to claim 2, wherein said starter includes a transmitter, and a control device.

8. An apparatus according to claim 7, wherein said control device comprises at least one stand-alone microprocessor.

9. An apparatus according to claim 7, wherein said control device comprises a microprocessor connected through said transmitter to a remote host or to a remote computer network.

10. An apparatus according to claim 2, wherein said timing-transponder device comprises time measuring means and means for managing external memory devices and external parametric sensors.

11. An apparatus according to claim 2, wherein said timing-transponder comprises an electronic clock, at least one memory, at least one microprocessor, a receiver associated to a first antenna, a radio-frequency transceiver associated to a second antenna, at least one parametric sensor.

12. An apparatus according to claim 11, wherein said receiver is chosen from the group comprising microwave receivers, millimetre waveband receivers and optical waveband receivers.

13. An apparatus according to claim 11, wherein said at least one parametric sensor is selected from the group comprising temperature, pressure, opening or anti-tampering and humidity sensors.

14. An apparatus according to claim 11, wherein said electronic clock is programmable by means of coded digital information received through said receiver from said starter on said up-link channel.

15. An apparatus according to claim 11, wherein said electronic clock is programmable by means of coded digital information received through said radio-frequency transceiver on said down-link channel.

16. An apparatus according to claim 11, wherein said receiver is selected from the group comprising microwave receivers, millimetre waveband receivers and optical waveband receivers.

17. An apparatus according to claim 2, wherein said starter and said radio-frequency transceiver are integrated in a single device comprising a microwave transmitter, a radio-frequency receiver-transmitter, at least one microprocessor, a first antenna associated to said microwave transmitter and a second antenna associated to said radio-frequency receiver-transmitter.

18. An apparatus according to claim 17, wherein said first antenna associated to said microwave transmitter is directional and said second antenna associated to said radio-frequency receiver-transmitter is omnidirectional.

19. An apparatus according to claim 17, wherein a software is associated to said at least one microprocessor, adapted to perform the function of driving the microwave signal output of the microwave communication channel, named up-link channel, managing said radio-frequency receiver-transmitter, and performing possible accessory control functions.

20. An apparatus according to claim 19, wherein said accessory control functions carried out by said software associated to said microprocessor comprise:
starting, resetting, setting out again and synchronising the chronometer of said timing-transponder;
requesting the storage of the instant time data measured by the chronometer on the memory of said timing-transponder;
requesting the receiving, the storage and, if necessary, the re-transmission of data existing on said down-link channel;
allowing the synchronization of the chronometer of said timing-transponder with a reference chronometer, the time data of which are transmitted by said starter on said up-link channel during activation step or on said down-link channel by said radio-frequency transceiver;
requesting the acquisition and storage of parameters measured by sensors possibly integrated on said timing-transponder;
parameterizing the transmissions of said timing-transponder indicating the periodicity thereof and the type of data to be transmitted on said down-link channel;
parameterizing the acquisitions and storages of parameters measured by said sensors indicating the periodicity, the storage modes and the time mark thereof; and
defining the communication protocol and the data format to be used for communications on said down-link channel.

21. Method for tracing objects, people or resources comprising the following steps:
a starter device is associated to each access to a determined region of space to be monitored;
a starter device is associated to each exit from a determined region of space to be monitored;
a timing-transponder device is associated to each object, person or resource to be monitored within the aforementioned region of space to be monitored;
upon access within said region of space to monitor by said timing-transponder devices, said starter activates said timing-transponder devices and programmes them so that these periodically transmit, with a period defined by their internal clock, a predefined code, which may be incremental;
said timing-transponder devices continue to transmit said predefined code until they receive an opposite command;
said timing-transponders also use their internal clock to synchronise periodic transmissions of their identification code or the acquisition, storage and/or re-transmission of other possible information deriving from sensors integrated on the mobile device, positioned on the object to monitor.
Upon exit from said region of space to be monitored by the timing-transponder devices, said starter device positioned at said exit orders a command opposite to that outputted by said first starter positioned at said input to said region of space to be monitored and such that said timing-transponder is re-programmed.

22. Method of automatic timing, comprising the following steps:
a timing-transponder device is associated to every object, person or resource, the movements of which are to be timed;
said timing-transponder device receives from a starter positioned in an appropriate position, a trigger signal on the up-link channel such that it links said timing-transponder device to the absolute time.
As an alternative to the previous step, said timing-transponder device receives the absolute time data on the down-link radio-frequency distance from the radio-frequency transmitter connected in turn to the absolute clock;
said starter continuously transmits the coded trigger signal on the up-link channel, which may be a simple reset code or it may contain in turn the reference time data.
Said timing-transponder device autonomously measures the deviations (relative or partial times) or the absolute time, and stores the time slots separating several events associated to several starters appropriately distributed or to consecutive transmissions of the same starter.
After an appropriate command ordered by a starter, the timing-transponder transmits on the down-link channel the complete or partial contents of its memory associating it to its identification code.

23. A method for surveilling and registrating the opening and closing of a container, comprising the following steps:
a timing-transponder device, connected to a break-in proof or anti-tampering sensor, is associated to each container, the movements of which are to be timed;
said timing-transponder device receives from a starter positioned in appropriate position, a trigger signal on the up-link channel such that said timing-transponder device is linked to the absolute time.
As an alternative to the previous step, said timing-transponder device receives the absolute time data on the down-link radio-frequency distance from the radio-frequency transmitter connected in turn to the absolute clock;
said timing-transponders associated to said containers register and temporally mark all of the openings of the access gates of said containers sensed by the break-in proof sensors interfaced to them.
Upon appropriate command ordered by a starter, said timing-transponders transmit on the down-link channel the complete or partial contents of their memory associating it to their identification code.
